(19) United States
(12) Patent Application Publication
(10) Pub. No.: US 2021/0065102 A1
(43) Pub. Date: Mar. 4, 2021

(54) PRODUCT INVENTORY MANAGEMENT APPARATUS AND METHOD

(71) Applicant: TOSHIBA TEC KABUSHIKI KAISHA, Tokyo (JP)

(72) Inventor: Kota SUZUKI, Izunokuni Shizuoka (JP)

(21) Appl. No.: 16/897,582

(22) Filed: Jun. 10, 2020

(30) Foreign Application Priority Data
Aug. 26, 2019 (JP) 2019-154076

(51) Int. Cl. G06Q 10/08; H04W 4/35; G06K 9/00

(52) U.S. Cl. CPC G06Q 10/087; G06K 9/00671; H04W 4/35

(57) ABSTRACT

A product inventory management system includes a sensor and a processing device. The sensor is configured to sense a pick-up and a placement of a product at a predetermined location that is associated with an identifier. The processing device is configured to, in response to detecting a product pick-up, increase a product pick-up counter and add a pick-up history log to the pick-up history. Each pick-up history log indicates a pick-up time corresponding to the pick-up detection time. The processing device removes a pick-up history log associated with the identifier from the pick-up history when the sensor detects a product placement. After the elapsing of predetermined time from the pick-up time included in a pick-up history log, the processing device increases a purchase counter associated with the identifier.

### CROSS-REFERENCE TO RELATED APPLICATION

This application is based upon and claims the benefit of priority from Japanese Patent Application No. 2019-154076, filed on Aug. 26, 2019, the entire contents of which are incorporated herein by reference.

### FIELD

Embodiments described herein relate generally to a product inventory management apparatus and a method for product inventory management.

### BACKGROUND

A product inventory management system that recognizes changes the number products (also referred to as commodities, items, and/or articles) at a store location by using a sensor, such as a camera, has been proposed. For such a system, there is an additional preference for being able identify how many times particular commodities have been picked up at, in addition to being removed from, the place where such commodities are displayed or otherwise stored.

### DESCRIPTION OF THE DRAWINGS

FIG. 1 illustrates a layout example of a store in which a store system according to an embodiment is introduced.

FIG. 2 illustrates an example view of an inventory location at a store as viewed from the side.

FIG. 3 is a block diagram of a store system according to an embodiment.

FIG. 4 is a diagram of a status table.

FIG. 5 is a diagram of a history table.

FIGS. 6-13 are flowcharts of processing associated with a store system according to an embodiment.

### DETAILED DESCRIPTION

In general, according to an embodiment, an inventory management system includes a sensor, a storage device, a display, and a processing device. The sensor is configured to sense a pick-up and a placement of a product at a predetermined location associated with an identifier. A pick-up history is stored in the storage device. The processing device is configured to, in response to the sensor detecting a product pick-up at the predetermined location, increase a product pick-up counter associated with the identifier by one and add a pick-up history log associated with the identifier to the pick-up history. Each pick-up history log in the pick-up history indicates a pick-up time corresponding to the detection of the product pick-up by the sensor. The processing device is configured to, in response to the sensor detecting a product placement at the predetermined location, remove a pick-up history log associated with the identifier from the pick-up history. The processing device is configured to increase a purchase counter associated with the identifier by one for each pick-up history log for which a predetermined time period after the pick-up time in the pick-up history log has elapsed. The processing device is configured to control the display to display a value of the product pick-up counter and a value of the purchase counter in association with the identifier.

Hereinafter, an example of a store system according to an embodiment will be described with reference to the drawings. in the drawings are, in general, schematic, the depicted dimensions of the various parts are not necessarily to scale and such dimensions and relationships between dimensions may be appropriately changed. In addition, in the drawings, some aspects of configuration(s) may be omitted for purposes of description. Furthermore, in the drawings and the specification, the same reference numerals are intended to denote the same or substantially the same elements.

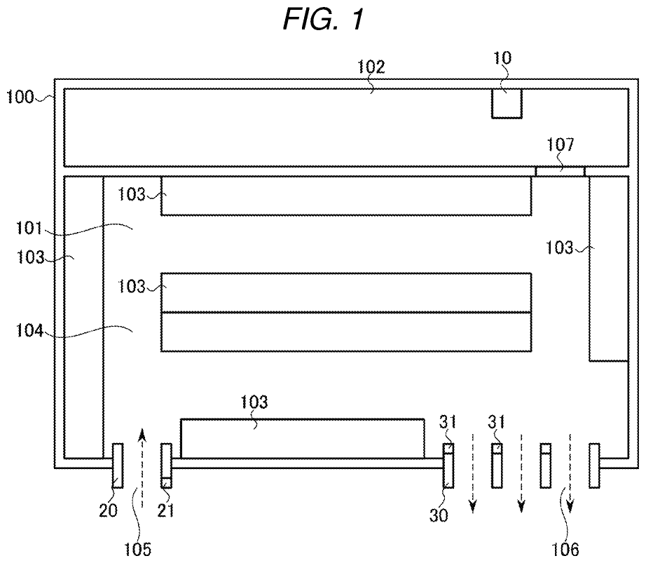

FIG. 1 illustrates a layout example of a store 100 in which a store system 1 according to an embodiment may be introduced.

The store system 1 is used for processing payments for a commodity according to a sensing that a shopper has picked up the commodity from a shelf or the like. The store system 1 using a sensor or sensors placed in the store to detect when a shopper has removed a commodity from the shelf or other product display region. The store system 1 is an example of a product inventory management system.

The store 100 includes a sales floor 101, a back office 102, a shelf 103, a passage 104, an entrance 105, an exit 106, and an employee entrance 107.

The sales floor 101 is a space where commodities to be sold at the store 100 are displayed. The shelf 103 and the like are provided on the sales floor 101.

The back office 102 is a storage space where commodity stocks are kept prior to being displayed on the sales floor 101. The back office 102 also includes various facilities and equipment used for operations of the store 100.

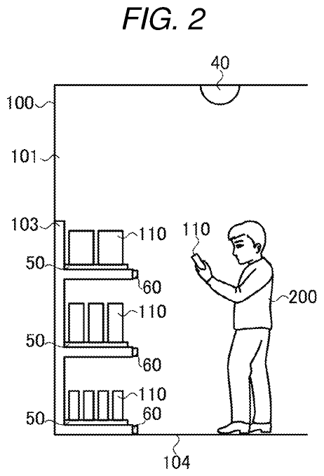

A shelf 103 will be described with reference to FIG. 2. FIG. 2 illustrates an example view of an inventory location in the store viewed from the side. Thus, the shelf 103 in FIG. 2 shows a state as viewed from the side. The shelf 103 is a shelf on which a commodity 110 or the like can be placed. Also, as depicted in FIG. 2, a shopper 200 picking up a commodity 110 is shown. The commodity 110 is an example of a product that is for sale at the store.

The passage 104 is a passage through which a shopper and an employee of the store 100 can pass. The passage 104 is between the shelves 103 or the like (see FIG. 1).

As seem in FIG. 1, the entrance 105 permits a shopper to enter the store 100. More particularly, the entrance 105 is an entrance for a shopper to enter the sales floor 101.

The exit 106 is an exit for a shopper to leave the store 100. More particular, the exit 106 is an exit for a shopper to leave the sales floor 101.

The employee entrance 107 permits an employee or the like to move between the sales floor 101 and the back office 102.

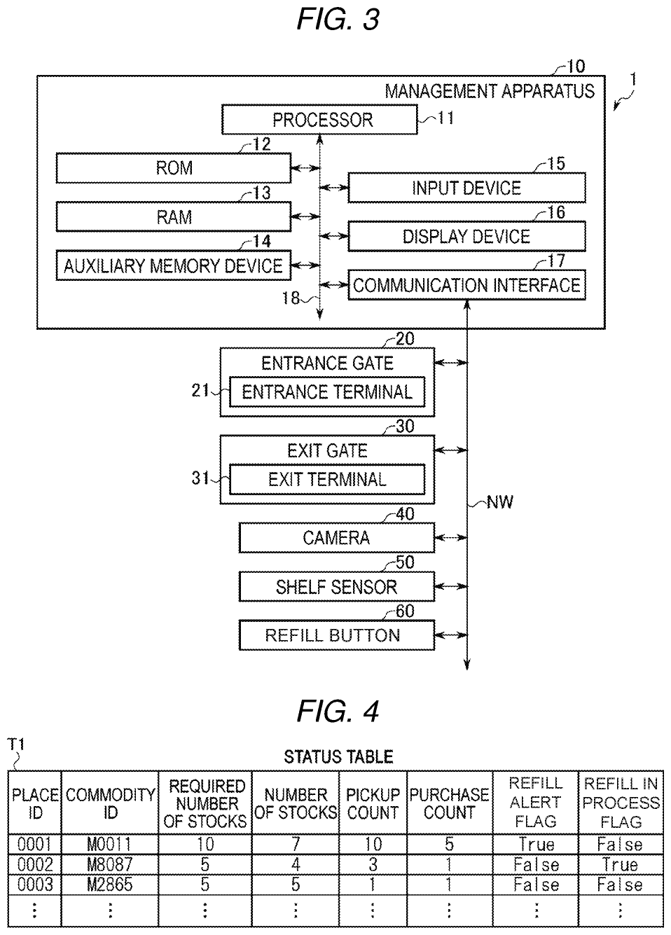

FIG. 3 is a block diagram showing an example of the store system 1 according to an embodiment and a configuration of components included in the store system 1. The store system 1 includes, for example, a management apparatus 10, an entrance gate 20, an exit gate 30, a camera 40, a shelf sensor 50, and a refill button 60 (also referred to as restock button 60).

The management apparatus 10 controls the store system 1. The management apparatus 10 is installed in, for example, the back office 102 of the store 100. The management apparatus 10 includes, for example, a processor 11, a read-only memory (ROM) 12, a random-access memory (RAM) 13, an auxiliary memory device 14, an input device 15, a display device 16, and a communication interface 17. A bus 18 connects the components to each other. The management apparatus 10 is an example of a product management apparatus.

The processor 11 corresponds to a central part of a computer that performs processing, such as calculations and controls, necessary for an operation of the management apparatus 10. The processor 11 may be referred to as a processing device. The processor 11 controls each unit to implement various functions of the management apparatus 10, based on a program, such as firmware, system software, and application software, stored in the ROM 12 or the auxiliary memory device 14. Here, a part or all of the program may be incorporated in a circuit of the processor 11. The processor 11 is, for example, a central processing unit (CPU), a micro processing unit (MPU), a system on a chip (SoC), a digital signal processor (DSP), a graphics processing unit (GPU), an application specific integrated circuit (ASIC), a programmable logic device (PLD), or a field-programmable gate array (FPGA). Alternatively, the processor 11 is a combination thereof.

The ROM 12 corresponds to a main memory apparatus of a computer having the processor 11 as a center. The ROM 12 is a nonvolatile memory used exclusively for reading data. The ROM 12 stores, for example, firmware or the like. The ROM 12 also stores data used when the processor 11 performs various processes.

The RAM 13 corresponds to a main memory apparatus of a computer having the processor 11 as a center. The RAM 13 is a memory used for reading and writing data. The RAM 13 is used as a work area for storing data temporarily used when the processor 11 performs various processes. The RAM 13 is normally a volatile memory.

The auxiliary memory device 14 corresponds to an auxiliary memory apparatus of a computer having the processor 11 as a center. The auxiliary memory device 14 is, for example, an electric erasable programmable read-only memory (EEPROM), a hard disk drive (HDD), or a flash memory. The auxiliary memory device 14 stores, for example, system software and application software among the program. Also, the auxiliary memory device 14 stores data used when the processor 11 performs various processes, data generated by the processor 11 via the processes, and various setting values.

Also, the auxiliary memory device 14 stores a status table T1 and a history table T2.

FIG. 4 is a diagram showing an example of the status table T1. The status table T1 shows a status for each place where the commodity 110 is placed. The status table T1 associates a place identifier (ID) with a commodity ID, the required stocked number (“required number of stocks”), the stocked number (“number of stocks”), a pick-up count (“pickup count”), a “purchase count,” a “refill alert flag,” and a “refill in process flag.”

The place ID is an identification indicating a specific region in the store. Each place ID indicates a different region. The place ID corresponds, for example, to a specific region on a shelf 103.

The commodity ID in the status table T1 indicates an identification of the commodity 110 placed in a region specified by the associated place ID. The commodity ID is a unique identification for each kind of the commodity 110. The commodity ID is, for example, a Japanese Article Number (JAN) code.

The required stocked number indicates the minimum number of commodities to be placed in a range specified by the associated place ID. When the number of commodities in the range is less than the required number, this indicates that the commodities need to be replenished at that location via stocking.

The stocked number indicates the number of commodities currently in a region specified by the associated place ID. The “number of stocks” in the status table T1 is an example of a value of an inventory counter.

The pick-up count indicates the number of times a commodity placed in a region specified by the associated place ID has been picked up (removed) by a shopper or the like. The pick-up count in the status table T1 is an example of a value of a product pick-up counter.

The purchase count indicates the number of times a commodity placed in a region specified by an associated place ID has been purchased. The purchase count in the status table T1 is an example of a value of a purchase counter.

The refill alert flag indicates that it is necessary to refill commodities in a region specified by the associated place ID.

The refill in process flag indicates that a product refill is being processed in a region specified by the associated place ID.

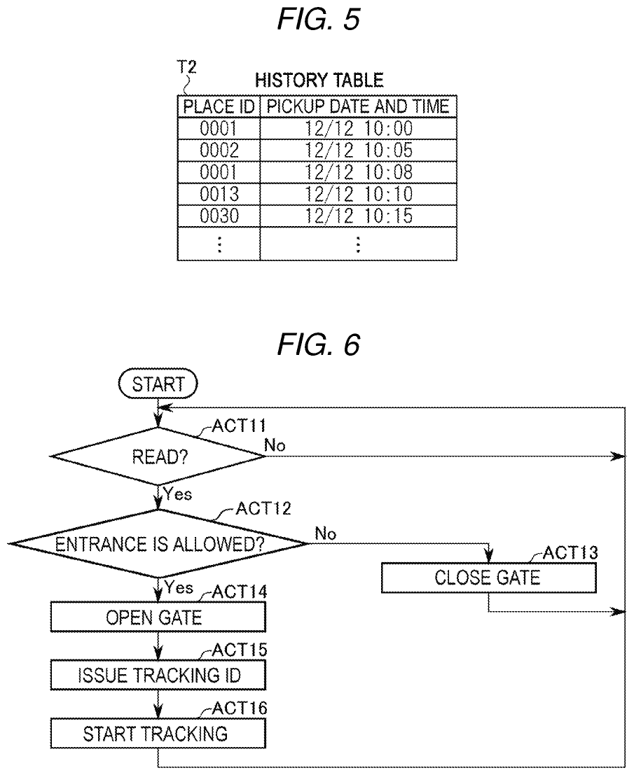

FIG. 5 is a diagram showing an example of the history table T2. The history table T2 stores a history (e.g., history log) in which it is noted when the commodity 110 has been picked up in the store 100. The history table T2 associates a place ID with a pick-up date and time.

The pick-up date and time indicates a date and time at which a commodity was picked up from a range/region specified by the associated place ID.

Also, the auxiliary memory device 14 stores a commodity database (DB). The commodity DB stores various types of information about each commodity sold at the store 100. The commodity DB stores various types of information in association with a commodity ID.

The program stored in the ROM 12 or the auxiliary memory device 14 includes a program for executing processing described below. For example, the management apparatus 10 is provided to a store manager in a state in which the program is stored in the ROM 12 or the auxiliary memory device 14. However, the management apparatus 10 may be provided in a state in which the program is not stored in the ROM 12 or the auxiliary memory device 14. Further, the management apparatus 10 may be provided in a state in which a program different from the program has been stored in the ROM 12 or the auxiliary memory device 14. Then, in such case, a program for executing the processing described below may be separately provided, and then written to the ROM 12 or the auxiliary memory device 14 by an operation of the manager or a service person. At this time, the program may be provided by, for example, recording the program on a removable storage medium, such as a magnetic disk, a magneto-optical disk, an optical disk, or a semiconductor memory, or by downloading the program via a network NW.

The input device 15 receives an operation by an operator of the management apparatus 10. The input device 15 is, for example, a keyboard, a keypad, a touchpad, or a mouse. The operator of the management apparatus 10 is, for example, an employee of the store 100.

The display device 16 displays a screen for notifying the operator of the management apparatus 10 of various types of information. The display device 16 is, for example, a liquid crystal display or an organic electro-luminescence (EL) display. Also, a touch panel may be used as the input device 15 and the display device 16. In other words, a display panel included in the touch panel may be used as the display device 16 and a touch pad included in the touch panel may be used as the input device 15.

The communication interface 17 is an interface through which the management apparatus 10 communicates with the entrance gate 20, the exit gate 30, the camera 40, the shelf sensor 50, and the refill button 60 through the network NW or the like.

The network NW is a communication network generally including a private network, such as an Intranet or the like. The network NW is a communication network generally including a local area network (LAN). However, the network NW may be a communication network including the Internet. The management apparatus 10, the entrance gate 20, the exit gate 30, the camera 40, the shelf sensor 50, and the refill button 60 are connected to the network NW.

The bus 18 includes a control bus, an address bus, and a data bus to transmit signals transmitted and received by each unit of the management apparatus 10.

As shown in FIG. 1, the entrance gate 20 is provided at the entrance 105. The entrance gate 20 closes the entrance 105 such that a shopper who is not allowed to enter the store 100 does not enter the store 100. Also, the entrance gate 20 opens the entrance 105 such that a shopper who is allowed to enter the store 100 enters the store 100. The entrance gate 20 includes an entrance terminal 21.

The entrance terminal 21 reads identification information from an electronic device or the like, such as an integrated circuit (IC) card or a smartphone possessed by a shopper who is to enter the store 100. Alternatively, the entrance terminal 21 reads biometric information such as features of a face or features of a fingerprint of a shopper trying to enter the store 100. Also, the identification information or biometric information read by the entrance terminal 21 is used to determine whether a shopper can enter the store 100.

As shown in FIG. 1, the exit gate 30 is provided at the exit 106. The exit gate 30 closes the exit 106 such that a shopper who is not allowed to exit the store 100 does not exit the store 100. Also, the exit gate 30 opens the exit 106 such that a shopper who is allowed to exit the store 100 exits the store 100. The exit gate 30 includes an exit terminal 31.

The exit terminal 31 performs processing for payment of a price of a commodity purchased by a shopper. In this regard, the exit terminal 31 reads, for example, identification information from an electronic device or the like, such as an IC card or a smartphone possessed by a shopper trying to exit the store 100. Alternatively, the exit terminal 31 reads, for example, biometric information, such as features of a face or features of a fingerprint of a shopper trying to exit the store 100.

As shown in FIG. 2, the camera 40 is provided on a ceiling portion of the sales floor 101. The camera 40 is an example of a sensor. Although only one camera 40 is shown in FIGS. 2 and 3, a plurality of cameras 40 are generally provided around the sales floor 101. The camera 40 captures images of the sales floor 101 region and outputs the captured images. The images are generally frames of video images. The management apparatus 10 tracks, for example, a shopper based on the image captured by the camera 40. Also, the management apparatus 10 senses, for example, that the commodity 110 is removed from the shelf 103 and the commodity 110 is placed on the shelf 103 based on the image captured by the camera 40.

As shown in FIG. 2, the shelf sensor 50 is a sensor provided at the shelf 103. The shelf sensor 50 outputs measurement information including a measurement amount. The shelf sensor 50 is used to sense that the commodity 110 is removed from the shelf 103 and the commodity is placed on the shelf 103. The shelf sensor 50 is, for example, a weight sensor or an optical sensor.

As shown in FIG. 2, the refill button 60 is a button provided on or proximate to the shelf 103. The refill button 60 can be operated by an employee or the like when replenishing the commodity 110 on the shelf 103, that is, when starting a product restocking. Also, the refill button 60 is operated by the employee or the like when ending the replenishing of the commodity 110 on the shelf 103, that is, when ending the restocking. Refill buttons 60 are provided, for example, one for each place corresponding to a place ID. The auxiliary memory device 14 stores a place as indicated by which place ID is assigned to each refill button 60. Alternatively, a place ID for the place where each refill button 60 is located can be stored. When the refill button 60 is pressed, a signal indicating the place ID is asserted, that is, information required for specifying the place ID is output. The refill button 60 is an example of an operation element or input apparatus.

Hereinafter, operations of the store system 1 according to the embodiment will be described with reference to FIGS. 6 through 13. The content of processing in the following description of the operations is only an example, and various processing capable of obtaining the same result may be appropriately used. FIGS. 6 through 13 are flowcharts showing examples of processing by the processor of the management apparatus 10. The processor 11 executes the processing based on, for example, a program stored in the ROM 12 or the auxiliary memory device 14. Also, the processor 11 executes, for example, the processing of FIGS. 6 through 13 simultaneously or in parallel.

When entering the store 100, a shopper causes the entrance terminal 21 to read a membership card or the like. Alternatively, when the shopper tries to enter the store 100 from the entrance gate 20, the entrance terminal 21 reads biometric information from the shopper. The membership card is, for example, an IC card or an electronic device on which a certain application is installed.

In ACT 11 of FIG. 6, the processor 11 stands by for the entrance terminal 21 to read identification information or biometric information. When the entrance terminal 21 reads the identification information or the biometric information, the processor 11 determines Yes in ACT 11 and the process proceeds to ACT 12.

In ACT 12, the processor 11 determines whether entrance into the store 100 is allowed or not. For example, when the identification information or the biometric information read in ACT 11 belongs to a member who completed member registration, the processor 11 determines that the entrance is allowed. Each member is provided with a member ID. The member ID is an identification mark unique to each member. When it is determined that the entrance is not allowed, the processor 11 determines No in ACT 12 and the process proceeds to ACT 13.

In ACT 13, the processor 11 closes the entrance gate 20. After the processing of ACT 13, the process returns to ACT 11.

On the other hand, when it is determined that the entrance is allowed, the processor 11 determines Yes in ACT 12 and the process proceeds to ACT 14. In ACT 14, the processor 11 opens the entrance gate 20.

In ACT 15, the processor 11 issues a tracking ID. The tracking ID is an identification mark unique to each visitor who entered the store 100 from the entrance gate 20. Further, the processor 11 associates the issued tracking ID with a member ID of the visitor. In addition, the processor 11 generates a commodity list for each tracking ID. The commodity list is a list of the commodities 110 purchased by a shopper specified by the tracking ID. For example, when the shopper 200 picks up the commodity 110 from the shelf 103, the commodity 110 is registered in the commodity list.

In ACT 16, the processor 11 starts tracking the visitor specified by the tracking ID issued in ACT 15. For example, the processor 11 performs the tracking by continuously specifying a position of the visitor in the store 100 by using an image of the camera 40. As such, the processor 11 is able to specify the tracking ID and the member ID of each person in the store 100. The processor 11 continues the tracking until the visitor exits the store 100. After the processing of ACT 16, the process returns to ACT 11.

The shopper picks up a commodity 110 to be purchased or at least a commodity 110 of interest from the shelf 103.

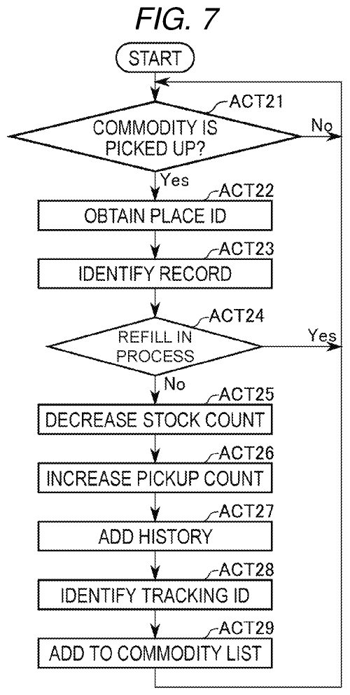

In ACT 21 of FIG. 7, the processor 11 determines whether the commodity 110 has been picked up from the shelf 103. The processor 11 senses that the commodity 110 has been picked up by using, for example, at least one of an image output by a camera 40 and measurement information output by a shelf sensor 50. When the processor 11 does not sense that the commodity 110 has been picked up from the shelf 103, the processor 11 determines No in ACT 21 and repeats ACT 21. On the other hand, when the processor 11 senses that the commodity 110 has been picked up from the shelf 103, the processor 11 determines Yes in ACT 21 and the process proceeds to ACT 22.

As described above, the processor 11 works in conjunction with at least one camera 40 or shelf sensor 50 to perform the processing of ACT 21, thereby functioning as a sensing unit for sensing that the commodity 110 has been removed. Alternatively, the processor 11 can be considered to function as a sensing unit simply by performing the processing of ACT 21.

In ACT 22, the processor 11 obtains a place ID of a place from which the picked up commodity 110 was initially placed. For example, the processor 11 obtains the place ID identifying the place where the picked up commodity 110 by using at least one of the image output by the camera 40 or the measurement information output by the shelf sensor 50. The place from which the picked up commodity 110 was previously located is hereinafter referred to as a “pick-up place”. Also, a place ID for the pick-up place obtained in ACT 22 is hereinafter referred to as a “pick-up place ID”.

In ACT 23, the processor 11 specifies a record in which a value of a place ID field is the pick-up place ID from records in the status table T1. The record specified here is referred to as a “pick-up record”.

In ACT 24, the processor 11 determines whether a product refill is being performed at the pick-up place. For example, when a value of the refill in process flag of the pick-up record is True, the processor 11 determines that the product refill is being performed at the pick-up place. When the value of the refill in process flag of the pick-up record is True and it is determined that the product refill is being performed at the pick-up place, the processor 11 determines Yes in ACT 24 and the process returns to ACT 21. On the other hand, when the value of the refill in process flag of the pick-up record is False and it is determined that the product refill is not performed at the pick-up place, the processor 11 determines No in ACT 24 and the process proceeds to ACT 25.

In ACT 25, the processor 11 decreases a value of a stock count field of the pick-up record by one. However, this is performed when one commodity 110 is picked up from the shelf 103. When the plurality of commodities 110 are picked up from the shelf 103 at one time, the processor 11 decreases the value of the stock count field of the pick-up record by the number of picked up commodities 110.

In ACT 26, the processor 11 increases the value of the pick-up count field of the pick-up record by one. However, this is performed when one commodity 110 is picked up from the shelf 103. When the plurality of commodities are picked up from the shelf 103, the processor 11 increases the value of pick-up count field of the pick-up record by the number of picked up commodities 110.

Therefore, by performing the processing of ACT 26, the processor 11 functions as a first counting unit for counting the removed number of commodities 110.

In ACT 27, the processor 11 adds a new record to the history table T2. A value of a place ID field of the new record is the pick-up place ID. A pick-up date and time record of the new record is a date and time when the commodity 110 is picked up. The processor 11 obtains, for example, a current date and time between ACT 21 and ACT 27 and uses the obtained date and time as a value of the pick-up date and time record. When the plurality of commodities 110 are picked up from the shelf 103 at one time, the processor 11 adds the new records by the number of picked up commodities 110.

In ACT 28, the processor 11 specifies and obtains the tracking ID of the shopper who picked up the commodity 110.

In ACT 29, the processor 11 registers a commodity in the commodity list by adding the commodity ID of the picked up commodity 110 to the commodity list for the tracking ID obtained in ACT 28. The process returns to ACT 21 after the processing of ACT 29.

The shopper returns the picked up commodity 110 to the place where the commodity 110 was originally placed when, for example, the purchase is stopped.

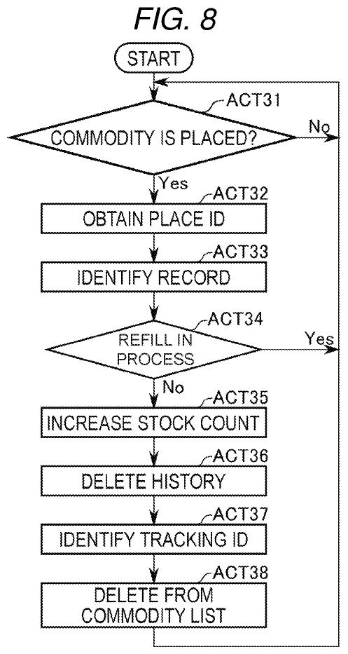

In ACT 31 of FIG. 8, the processor 11 determines whether the commodity 110 is placed on the shelf 103 or the like. The processor 11 senses that the commodity 110 has been placed by using, for example, at least one of the image output by the camera 40 or the measurement information output by the shelf sensor 50. When it is not sensed that the commodity 110 has been placed on the shelf 103 or the like, the processor 11 determines No in ACT 31 and thus the process repeats ACT 31. On the other hand, when it is sensed that the commodity 110 has been placed on the shelf 103 or the like, the processor 11 determines Yes in ACT 31 and the process proceeds to ACT 32.

In ACT 32, the processor 11 obtains the place ID of the place where the placement of the commodity 110 is sensed. For example, the processor 11 obtains the place ID corresponding to the place by specifying the place where the commodity 110 is placed by using at least one of the image output by the camera 40 and the measurement information output by the shelf sensor 50. The place where the commodity 110 is placed is hereinafter referred to as a “placed place”. A place ID of the placed place obtained in ACT 32 is hereinafter referred to as a “placed place ID”.

In ACT 33, the processor 11 specifies a record in which a value of a place ID field is a placed place ID from the records in the status table T1. The record specified here is referred to as a “placement record”.

In ACT 34, the processor 11 determines whether the product refill is being performed at the placed place. For example, when a value of a refill in process flag in the placement record is True, the processor 11 determines that the product refill is being performed at the placed place. When the value of the refill in process flag in the placement record is True and it is determined that the product refill is being performed at the placed place, the processor 11 determines Yes in ACT 34 and the process returns to ACT 31. On the other hand, when the value of the refill in process flag in the placement record is False and it is determined that the product refill is not performed at the placed place, the processor 11 determines No in ACT 34 and the process proceeds to ACT 35.

As described above, the processor 11 functions as a detecting unit for detecting that an operation of placing the commodity 110 is being performed by executing the processing of ACT 34.

In ACT 35, the processor 11 increases a value of a stock count field of the placement record by one. However, this is performed when one commodity 110 is picked up from the shelf 103. When the plurality of commodities 110 are placed on the shelf 103 at one time, the processor 11 increases the value of the stock count field of the placement record by the number of placed commodities 110.

In ACT 36, the processor 11 deletes a record with the oldest pick-up date and time from a record in which a value of a place ID field is the placed place ID in the history table T2. When the plurality of commodities 110 are placed on the shelf 103 at one time, the processor 11 sequentially deletes records in which the value of the place ID field is the placed place ID from the oldest pick-up date and time, by the number of placed commodities 110.

The processor 11 may prevent a commodity from being counted as being purchased before a certain time is elapsed after the commodity is picked up, by deleting the record with the oldest pick-up date and time.

In ACT 37, the processor 11 specifies and obtains a tracking ID of the shopper who placed the commodity 110.

In ACT 38, the processor 11 deletes a commodity from the commodity list by deleting the commodity ID of the placed commodity 110 from the commodity list for the tracking ID obtained in ACT 28. The process returns to ACT 31 after the processing of ACT 38.

When exiting the store 100, the shopper causes the exit terminal 31 to read the membership card or the like. Alternatively, when the shopper tries to exit the store 100 from the exit gate 30, the exit terminal 31 reads the biometric information from the shopper.

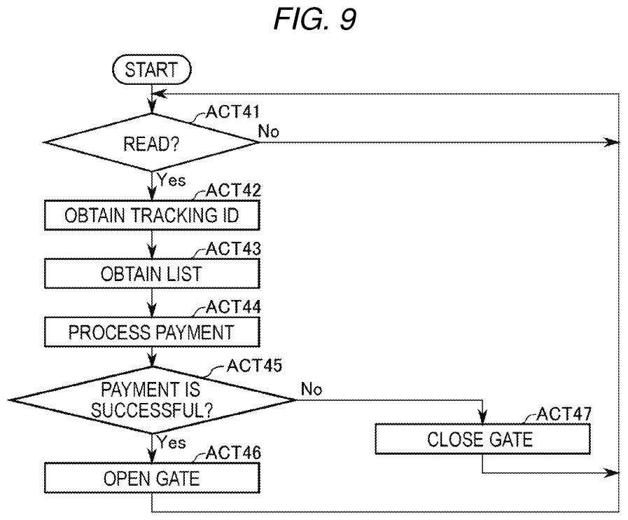

In ACT 41 of FIG. 9, the processor 11 stands by for the exit terminal 31 to read the identification information or the biometric information. When the exit terminal 31 reads the identification information or the biometric information, the processor 11 determines Yes in ACT 41 and the process proceeds to ACT 42.

In ACT 42, the processor 11 specifies and obtains the tracking ID of the shopper specified by the identification information or the biometric information read in ACT 41, who is going to exit the store 100 from the exit gate 30.

In ACT 43, the processor 11 obtains the commodity list for the tracking ID obtained in ACT 42.

In ACT 44, the processor 11 executes payment for the price of a commodity registered in the commodity list obtained in ACT 44. For example, the processor 11 executes the payment by using a payment method set by a member at a time of membership registration or the like. The payment method is, for example, electronic money, a credit card, or cash.

In ACT 45, the processor 11 determines whether the payment in ACT 44 is successful. When the payment in ACT 44 is successful, the processor 11 determines Yes in ACT 45 and the process proceeds to ACT 46.

In ACT 46, the processor 11 opens the exit gate 30. The process returns to ACT 41 after the processing of ACT 46.

On the other hand, when the payment in ACT 44 is not successful, the processor 11 determines No in ACT 45 and the process proceeds to ACT 47.

In ACT 47, the processor 11 closes the exit gate 30. The process returns to ACT 41 after the processing of ACT 47.

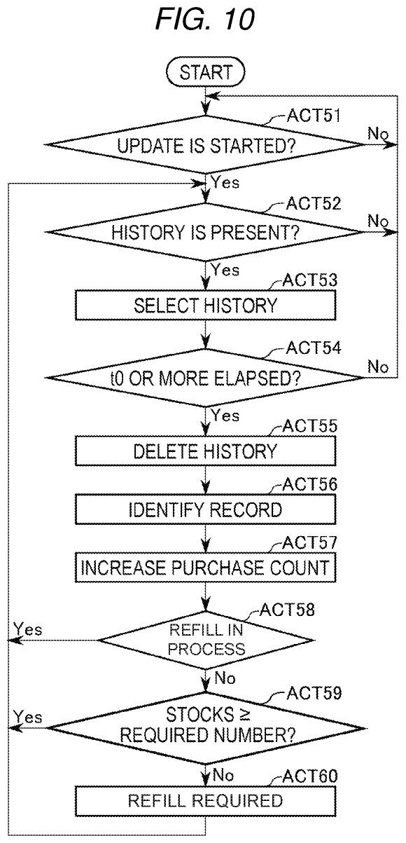

In ACT 51 of FIG. 10, the processor 11 determines whether to start updating the status table T1 and the history table T2. For example, the processor 11 starts to update the status table T1 and the history table T2 at regular time intervals. Also, the processor 11 starts to update the status table T1 and the history table T2 when there is an input of an instruction to update the status table T1 and the history table T2. When it is not determined that the updating of the status table T1 and the history table T2 is started, the processor 11 determines No in ACT 51 and repeats ACT 51. When it is determined that the updating of the status table T1 and the history table T2 is started, the processor 11 determines Yes in ACT 51 and the process proceeds to ACT 52.

In ACT 52, the processor 11 determines whether the history table T2 stores one or more histories. In other words, the processor 11 determines whether one or more records are included in the history table T2. When the history table T2 does not store any history, the processor 11 determines No in ACT 52 and the process returns to ACT 51. On the other hand, when the history table T2 stores one or more histories, the processor 11 determines Yes in ACT 52 and the process proceeds to ACT 53.

In ACT 53, the processor 11 selects the oldest one among histories included in the history table T2. In other words, the processor 11 selects a record with the oldest pick-up date and time among records of the history table T2.

In ACT 54, the processor 11 determines whether the pick-up date and time of the selected record is a date and time after a time t0 or more is elapsed from a current date and time. The time t0 is a pre-determined threshold value. The length of the time t0 is determined by, for example, a manager or designer of the store system 1. The time t0 is used to assume that the commodity 110 is purchased when the time t0 is elapsed since the commodity 110 is picked up. When the pick-up date and time is not the date and time after the time t0 or more is elapsed from the current date and time, the processor 11 determines No in ACT 54 and the process returns to ACT 51. On the other hand, when the pick-up date and time is the date and time after the time t0 or more is elapsed from the current date and time, the processor 11 determines Yes in ACT 54 and the process proceeds to ACT 55.

In ACT 55, the processor 11 deletes the selected record from the history table T2.

In ACT 56, the processor 11 specifies a record having a same place ID as the place ID included in the record deleted in ACT 55, from the records in the status table T1.

In ACT 57, the processor 11 increases a value of a purchase count field of the record specified in ACT 56 by one. Accordingly, by executing the processing of ACT 57, the processor 11 functions as a second counting unit that counts the number of purchased commodities 110.

In ACT 58, the processor 11 determines whether a product refill is being performed at a place specified by a place ID of the record specified in ACT 56. In other words, the processor 11 determines whether a value of a refill in process flag of the record specified in ACT 56 is True. When the value of the refill in process flag of the record specified in ACT 56 is True, the processor 11 determines Yes in ACT 58 and the process returns to ACT 52. On the other hand, when the value of the refill in process flag of the record specified in ACT 56 is False, the processor 11 determines No in ACT 58 and the process proceeds to ACT 59.

In ACT 59, the processor 11 determines whether the stocked number of the record specified in ACT 56 is equal to or greater than the required stocked number. When the stocked number is equal to or greater than the required stocked number, the processor 11 determines Yes in ACT 59 and the process returns to ACT 52. On the other hand, when the stocked number is less than the required stocked number, the processor 11 determines No in ACT 59 and the process proceeds to ACT 60.

In ACT 60, the processor 11 sets a value of a refill alert flag to True for the record specified in ACT 56. The process returns to ACT 52 after the processing of ACT 60.

As described above, by executing the processing of ACT 59, the processor 11 functions as a determining unit for determining that a product refill is required for a place where the stocked number is equal to or smaller than a certain number.

The operator of the management apparatus 10 may obtain various types of information and the like based on the status table T1 in the store 100 by operating the management apparatus 10.

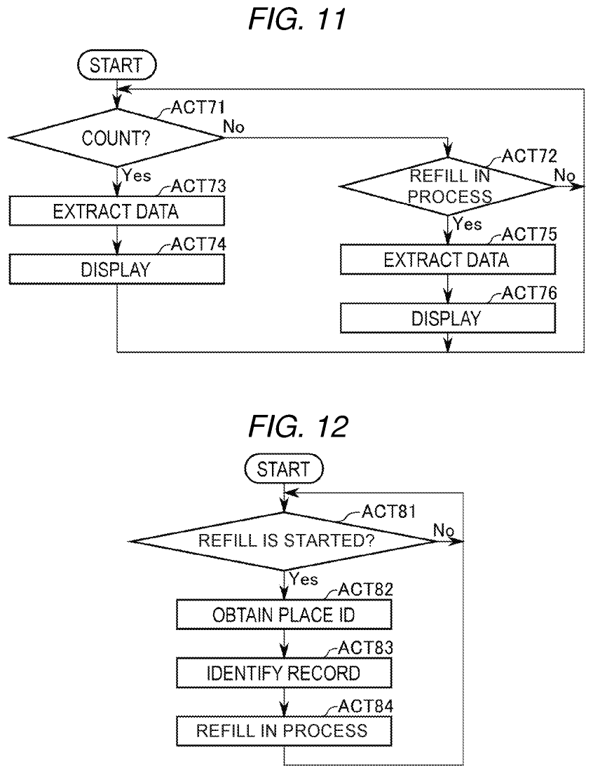

In ACT 71 of FIG. 11, the processor 11 determines whether there is an input requesting information regarding a count. The input requesting information regarding the count is, for example, based on an operation input to the input device 15. When there is no input requesting the information regarding the count, the processor 11 determines No in ACT 71 and the process proceeds to ACT 72.

In ACT 72, the processor 11 determines whether there is an input requesting information regarding a product refill. The input requesting the information regarding the stocking is based on, for example, an operation input to the input device 15. When there is no input requesting information regarding the product refill, the processor 11 determines No in ACT 72 and the process returns to ACT 71. As such, the processor 11 repeats ACT 71 and ACT 72 until there are the input requesting information regarding the count and the input requesting the information regarding the product refill.

When there is the input requesting the information regarding the count while ACT 71 and ACT 72 are in standby states, the processor 11 determines Yes in ACT 71 and the process proceeds to ACT 73.

In ACT 73, the processor 11 extracts all records by referring to the status table T1.

In ACT 74, the processor 11 generates an image corresponding to a count information screen. Then, the processor 11 instructs the display device 16 to display the generated image. Upon receiving an instruction to display, the display device 16 displays the count information screen. The process returns to ACT 71 after the processing of ACT 74.

The count information screen includes information about a pick-up count and a purchase count. For example, the count information screen includes a pick-up count and a purchase count for each place ID.

When there is the input requesting the information regarding the product refill while ACT 71 and ACT 72 are in the standby states, the processor 11 determines Yes in ACT 72 and the process proceeds to ACT 75.

In ACT 75, the processor 11 extracts a record in which a value of a refill alert flag is True by referring to the status table T1.

In ACT 76, the processor 11 generates an image corresponding to a product refill information screen. Then, the processor 11 instructs the display device 16 to display the generated image. Upon receiving an instruction to display, the display device 16 displays the product refill information screen. The process returns to ACT 71 after the processing of ACT 76.

The product refill information screen includes a list of place IDs where a product refill is required. The place ID where a product refill is required is a place ID where a value of a refill alert flag associated with the place ID is True. Also, the product refill information screen includes a display indicating the required stocked number, the stocked number, and the number obtained by subtracting the stocked number from the required stocked number, for each place ID where a product refill is required. The product refill information screen may include a display indicating information about a placed commodity for each place ID where a product refill is required. The information about a commodity is, for example, various types of information, such as a commodity ID and a commodity name. The processor 11 obtains various types of information, such as a commodity name by referring to a commodity DB, based on the commodity ID associated with the place ID.

The employee or the like of the store 100 identifies a place where a product refill is required by looking at the product refill information screen.

As described above, by executing the processing of ACT 76, the processor 11 functions as a notifying unit for notifying that the commodity 110 is required to be placed.

When the product refill is performed, for example, the employee of the store 100 obtains the commodity 110 required for the product refill from the back office 102 and enters the sales floor 101 through the employee entrance 107. Then, the employee performs a start operation on the refill button 60 at the place where the commodity 110 is to be placed to indicate starting of the product refill. Next, the employee replenishes the commodity 110 by placing the restocked commodity 110. The product refill is an operation of replenishing the commodity 110 at the appropriate place.

In ACT 81 of FIG. 12, the processor 11 stands by for a product refill to start. For example, the processor 11 determines that the product refill is started in response to the start operation on the refill button 60. When it is determined that the product refill is started, the processor 11 determines Yes in ACT 81 and the process proceeds to ACT 82.

In ACT 82, the processor 11 obtains a place ID of a place where the refill button 60 is provided, based on information output by the refill button 60 on which the start operation is performed.

In ACT 83, the processor 11 specifies a record having the same place ID as the place ID obtained in ACT 82 from the records in the status table T1.

In ACT 84, the processor 11 sets a value of a refill in process flag to True for the record specified in ACT 83. Also, the processor 11 sets a value of a refill alert flag to False for the record. The process returns to ACT 81 after the processing of ACT 84.

The employee replenishes (restocks) a commodity at the place where the refill button 60 is provided after performing the start operation on the refill button 60. Then, the employee who completed the replenishment of the commodity at the place performs an end operation on the refill button 60 to indicate that the product refill is ended. When commodities are to be replenished at a plurality of places, the employee performs the start operation and the end operation with the refill button 60 for each place to be restocked.

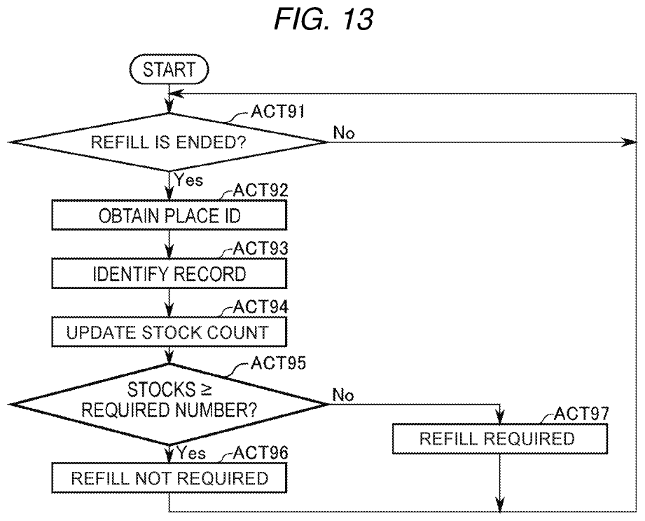

In ACT 91 of FIG. 13, the processor 11 stands by until the product refill is ended. For example, the processor 11 determines that the product refill is ended when the end operation is performed on the refill button 60. When it is determined that the product refill is ended, the processor 11 determines Yes in ACT 91 and the process proceeds to ACT 92.

In ACT 92, the processor 11 obtains a place ID of a place where the refill button 60 is provided, based on information output by the refill button 60 on which the end operation is performed.

In ACT 93, the processor 11 specifies a record having the same place ID as the place ID obtained in ACT 92 from the records in the status table T1.

In ACT 94, the processor 11 updates the stocked number (“stocks”) to the latest value for the record specified in ACT 93. For example, the processor 11 counts the number of commodities 110 placed at the place indicated by the place ID in the record during the product refill and updates the stocked number to the latest value by adding the counted number to the previous stock number. The processor 11 performs the counting by using, for example, at least one of the image output by the camera 40 or the measurement information output by the shelf sensor 50. Alternatively, the processor 11 may measure the number of commodities 110 currently placed at the place and add the number to the latest value of the stocked number by using at least one of the image output by the camera 40 or the measurement information output by the shelf sensor 50. Alternatively, the employee may input the latest stocked number or the number of refilled commodities 110 to a terminal device or the like by hand. The number input to the terminal device is ultimately input to the management apparatus 10. The processor 11 updates the stocked number to the latest value, based on the input number.

In ACT 95, the processor 11 determines whether the stocked number is equal to or greater than the required stocked number for the record specified in ACT 93. When the stocked number is equal to or greater than the required stocked number for the record specified in ACT 93, the processor 11 determines Yes in ACT 95 and the process proceeds to ACT 96.

In ACT 96, the processor 11 sets a value of a refill alert flag to False for the record specified in ACT 93. The process returns to ACT 91 after the processing of ACT 96.

On the other hand, when the stocked number is less than the required stocked number for the record specified in ACT 93, the processor 11 determines No in ACT 95 and the process proceeds to ACT 97.

In ACT 97, the processor 11 sets the value of the refill alert flag to True for the record specified in ACT 93. The process returns to ACT 91 after the processing of ACT 97.

According to the store system 1 of the embodiment, the management apparatus 10 counts the number of picked up commodities 110. Then, the management apparatus 10 displays the count information screen including the number of commodities 110 picked up for each place, based on the count. As such, the employee of the store 100 may identify the commodity 110 placed at which place is frequently picked up by looking at the count information screen.

Also, according to the store system 1 of this embodiment, the management apparatus 10 counts the number of purchased commodities 110. Then, the management apparatus 10 displays the count information screen including the number of purchased commodities 110 for each place, based on the count. Thus, the employee or the like of the store 100 can identify the commodity 110 placed at which place is frequently sold by looking at the count information screen.

Furthermore, according to the store system 1 of this embodiment, the management apparatus 10 stops counting the number of picked up commodities 110 when the refill in process flag is True. Thus, the management apparatus 10 does not count the number of commodities being picked up by an employee or the like during the product refill operation. Accordingly, the management apparatus 10 identifies the number of commodities 110 picked up by shoppers.

Further, according to the store system 1 of this embodiment, the management apparatus 10 determines that the product refill is required for places where the stocked number is less than the required stocked number, and sets the value of the refill alert flag to True. Then, the management apparatus 10 displays the product refill information screen including what is required to be stocked and the place, based on the value of the refill alert flag. Accordingly, the employee or the like of the store 100 identifies what is required to be stocked and the place where the product refill is required.

In addition, according to the store system 1 of this embodiment, the management apparatus 10 sets the value of the refill in process flag to True in response to the start operation performed on the refill button 60. As such, the management apparatus 10 may sense that the product refill is being performed at the place where the start operation was performed on the refill button 60.

Further, according to the store system 1 of this embodiment, the management apparatus 10 considers that a commodity 110 is purchased when the time from the date and time when the commodity 110 is picked up is equal to or greater than the time to. Thus, the management apparatus 10 may count the number of purchases via a simple process.

The product refill information screen includes a list of places where the stocked number is smaller than the required stocked number. Thus, the employee or the like of the store 100 may easily identify the place where the product refill is required by looking at the product refill information screen.

The embodiment may be modified in various aspects such as follows.

In the above-described embodiment, the processor 11 of the management apparatus 10 determines that the product refill is required when the stocked number is less than the required stocked number. However, the processor 11 may instead determine that the product refill is required by tracking the number of picked up counts.

In the above-described embodiment, the store system 1 performs unattended payment. However, it is also contemplated that the store system 1 may instead, or in addition, be configured to perform manned payment (manual checkout rather than automated checkout). In this case, the store 100 is provided with a POS terminal or the like for performing operations associated with the manned payment.

In the above-described embodiment, the store system 1 automatically registers a commodity in the commodity list when the commodity is picked up by a shopper. However, it is also contemplated that in the store system 1 according to the embodiment, a shopper or employee may manually perform registration of items to the commodity list.

In the above-described embodiment, the refill button 60 is provided at each place corresponding to a place ID. However, it is also contemplated that for the refill button 60, one common refill button 60 may be provided for places indicated by a plurality of place IDs. In this case, when the start operation or the end operation is performed on the refill button 60, for example, the processor 11 may set values for refill in process flags for a plurality of records to True or False at once.

In the above-described embodiment, the processor 11 determines that the product refill is being performed or not based on an operation on the refill button 60. However, the processor 11 may also or instead recognize what is being stocked and the place, based on information output by a sensor, such as an image captured by the camera 40 or the like. Then, the processor 11 changes a value of a refill in process flag associated with a place ID of the place where a product refill is recognized as being performed to True. In addition, the processor 11 may similarly recognize what items or locations have finished being stocked and the place, based on the information output by the sensor. Then, the processor 11 changes a value of a refill in process flag associated with a place ID of the place where an ending of the product refill is recognized to False.

In the above-described embodiment, an employee or the like determines whether the product refill is required and performs the product refill by checking the value of the refill alert flag or the like. However, it is also contemplated that a robot or the like may instead or in addition determine whether a product refill is required based on a value of a refill alert flag or the like and automatically perform product refill as necessary.

The store system 1 may use or incorporate a sensor other than the camera 40 and the shelf sensor 50.

In the above-described embodiment, an entrance and an exit are distinguished in the store, but in other examples the entrance and the exit may be in common.

The processor 11 may implement a part or all of processes by execution of instructions in a program according to the above embodiment or, in some examples, such processes may be implemented via a hardware component such as a dedicated or specialized hardware circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product inventory management system, comprising:
a sensor configured to sense a pick-up and a placement of a product at a predetermined location associated with an identifier;
a storage device in which a pick-up history is stored; a display; and
a processing device configured to:
in response to the sensor detecting a product pick-up at the predetermined location, increase a product pick-up counter associated with the identifier by one and add a pick-up history log associated with the identifier to the pick-up history, each pick-up history log in the pick-up history indicating a pick-up time corresponding to the time at which the product pick-up was detected;
in response to the sensor detecting a product placement at the predetermined location, remove a pick-up history log associated with the identifier from the pick-up history;
increase a purchase counter associated with the identifier by one for each pick-up history log associated with the identifier in the pick-up history after an elapsing of a predetermined time period from the pick-up time in the pick-up history log; and
control the display to display a value of the product pick-up counter and a value of the purchase counter in association with the identifier.

2. The product inventory management system according to claim 1, wherein the pick-up history log removed from the pick-up history is the oldest pick-up history log associated with the identifier in the pick-up history.

3. The product inventory management system according to claim 1, further comprising:
an operation element associated with the identifier and configured to assert a signal corresponding to a product refill state when a user performs an operation thereon, wherein
the processing device is further configured to disable changes to the product pick-up counter when the signal is asserted and enable changes to the product pick-up counter when the signal is deasserted.

4. The product inventory management system according to claim 3, wherein the processing device is further configured to:
reduce an inventory counter associated with the identifier by one in response to the sensor detecting the product pick-up at the predetermined location; and
increase the inventory counter associated with the identifier by one in response to the sensor detecting the product placement at the predetermined location, wherein
the display is further controlled to display a value of the inventory counter in association with the identifier.

5. The product inventory management system according to claim 4, wherein an alert prompting a product refill is displayed on the display in association with the identifier when the value of the inventory counter is less than a threshold value.

6. The product inventory management system according to claim 4, wherein the processing device is further configured to update the value of the inventory counter based on a sensing result of the sensor when the signal is deasserted.

7. The product inventory management system according to claim 4, wherein the processing device is further configured to disable changes to the inventory counter when the signal is asserted and enable changes to inventory counter when the signal is deasserted.

8. The product inventory management system according to claim 1, wherein the sensor includes a weight sensor at the predetermined location.

9. The product inventory management system according to claim 1, wherein the sensor includes an optical sensor at the predetermined location.

10. The product inventory management system according to claim 1, wherein the sensor includes a camera configured to capture images of the predetermined location.

11. A product inventory management method, comprising:
using a sensor to detect a pick-up of a product or a placement of a product at a predetermined location, the predetermined location being associated with an identifier;
in response to the sensor detecting a product pick-up at the predetermined location, increasing a product pick-up counter associated with the identifier by one and adding a pick-up history log associated with the identifier to a pick-up history, each pick-up history log in the pick-up history indicating a pick-up time corresponding to the time at which the product pick-up was detected;
in response to the sensor detecting a product placement at the predetermined location, removing a pick-up history log associated with the identifier from the pick-up history;
increasing a purchase counter associated with the identifier by one for each pick-up history log associated with the identifier in the pick-up history after an elapsing of a predetermined time period from the pick-up time in the pick-up history log; and
controlling a display to display a value of the product pick-up counter and a value of the purchase counter in association with the identifier.

12. The method according to claim 11, wherein the pick-up history log removed from the pick-up history is the oldest pick-up history log associated with the identifier in the pick-up history.

13. The method according to claim 11, further comprising:
asserting a signal corresponding to a product refill state when a user performs an operation on an operation element associated with the identifier;
disabling changes to the product pick-up counter when the signal is asserted and enabling changes to the product pick-up counter when the signal is deasserted.

14. The method according to claim 13, further comprising:
reducing an inventory counter associated with the identifier by one in response to the sensor detecting the product pick-up at the predetermined location;
increasing the inventory counter associated with the identifier by one in response to the sensor detecting the product placement at the predetermined location; and
controlling the display to display a value of the inventory counter in association with the identifier.

15. The method according to claim 14, further comprising:
controlling the display to display an alert prompting a product refill in association with the identifier when the value of the inventory counter is less than a threshold value.

16. The method according to claim 14, further comprising:
updating the value of the inventory counter based on a sensing result of the sensor when the signal is deasserted.

17. The method according to claim 14, further comprising:
disabling changes to the inventory counter when the signal is asserted and enabling changes to the inventory counter when the signal is deasserted.

18. The method according to claim 11, wherein the sensor includes a weight sensor at the predetermined location.

19. The method according to claim 11, wherein the sensor includes an optical sensor at the predetermined location.

20. The method according to claim 11, wherein the sensor includes a camera configured to capture images of the predetermined location.
